(19) United States
(12) Patent Application Publication
(10) Pub. No.: US 2003/0164806 A1
(43) Pub. Date: Sep. 4, 2003

(54) System and method for presenting information on a plurality of displays

(76) Inventor: Stephen F. Krempl, Plano, TX (US)

Correspondence Address: Michael L. Diaz, Michael L. Diaz, P.C., Suite 200, 555 Republic Drive, Plano, TX, 75074, US

(21) Appl. No.: 10/090,355

(22) Filed: Mar. 1, 2002

(51) Int. Cl. G09G 5/00

(52) U.S. Cl. 345/1.1

(57) ABSTRACT

A system and method of displaying information onto a plurality of display screens. The system includes a computing system which formats information inputted by an operator. The information is formatted as data packets which include an identification tag designating the ultimate destination of the data packet, as selected by the operator. The system also includes a switch box and a plurality of projection units. Each projection unit displays images onto an associated display screen. The switch box receives the data packets from the computing system and determines the appropriate destination. The switch box then sends each data packet to the designated projection unit for display onto its corresponding display screen. The presentation system enables one operator to present data on a plurality of screens through the use of a single computing system.

### BACKGROUND OF THE INVENTION

1. Technical Field of the Invention

This invention relates to audio-visual presentation systems, and more particularly, to a system and method for presenting information on a plurality of displays for an audience.

2. Description of Related Art

The presentation of information in an efficient and effective manner is quite often dependent upon the manner in which the information is presented to an audience. With the advent of computers, the effectiveness of audio-visual presentations has dramatically improved. A common system used in presenting information to an audience usually includes a laptop computer and a projection device. In such a configured system, a presenter provides visual, and sometimes audio, presentations by projecting images generated from software programs installed within the laptop through the projection system onto a single screen. This existing presentation system enables the presenter to provide information to the audience by manipulating controls located on the laptop.

Although the existing presentation systems provide a fairly versatile and effective in informing the targeted audience, the existing systems suffer from several disadvantages. It has been found that the most effective method of presenting information to people is through the use of three displays. Existing presentation systems merely allow the presentation of information on one display through one computer. In order to facilitate the presentation of three displays, three computers and three projection units are required. Since three presentation systems, each providing one display, must be used, three operators must be employed to manipulate the controls of each machine. Such a configuration is cumbersome and inefficient. An efficient system is needed which enables one presenter to manipulate the controls of three projection units to provide three different displays.

Thus, it would be a distinct advantage to have a presentation system and method which provides the presentation of three displays from a single control unit to an audience. It is an object of the present invention to provide such a system and method.

### SUMMARY OF THE INVENTION

In one aspect, the present invention is a system for presenting information onto a plurality of display screens. The system includes a computing system which receives information from an operator for presentation to an audience. The computing system formats the information into a plurality of data packets. Each data packet indicates a final destination designated from the received information. The system also includes a switch box communicating with the computing system. The switch box receives a plurality of data packets sent from the computing system and determines a destination of each data packet. In addition, the system includes a plurality of display screens providing a display of the information inputted into the computing system. The plurality of display screens communicates with the switch box to provide the inputted information on the display screens. The switch box, upon determining the destination of each data packet, sends the data packet to the designated display screen.

In another aspect, the present invention is a method of presenting information onto a plurality of display screens. The method begins by an operator inputting information into a computing system for display to one of a plurality of display screens. Next, the computing system formats the inputted information into a plurality of data packets. Each data packet indicates a destination to one of the display screens. The computing system then sends the plurality of data packets to a switch box. Next, the switch box determines a destination for the plurality of data packets to one of the plurality of display screens and sends the plurality of data packets to each determined destination from the plurality of display screens. Each determined display screen then displays the data packets to an audience.

In still another aspect, the present invention is a system for presenting information onto a plurality of display screens. The system includes a computing system which receives information from an operator for presentation to an audience. The computing system formats the information into a plurality of data packets. Each data packet indicates a final destination designated from the received information. The system also includes a switch box communicating with the computing system. The switch box receives a plurality of data packets sent from the computing system and determines a destination of each data packet. The switch box also includes a separation module for dividing data packets into groups based on a designated destination and a diversion module for determining the designated destination for each data packet received from the computing system. In addition, the system also includes a plurality of display screens for displaying information inputted into the computing system. The plurality of display screens communicates with the switch box for displaying the inputted information. Upon determining the destination of each data packet, the switch box sends the data packet to the designated display screen.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a system for presenting information onto a plurality of displays in the preferred embodiment of the present invention;

FIG. 2 is a simplified block diagram illustrating the influx of data packets through the switch box in the preferred embodiment of the present invention;

FIG. 3 is a flow chart outlining the steps for presenting information to a plurality of displays according to the teachings of the present invention;

FIG. 4 is a front view of a presentation system in an alternate embodiment of the present invention;

FIG. 5 is a rear view of the presentation system of FIG. 4; and

FIG. 6 is a front view of an integrated projection unit which may be incorporated within the system in a second alternate embodiment of the present invention.

### DETAILED DESCRIPTION OF EMBODIMENTS

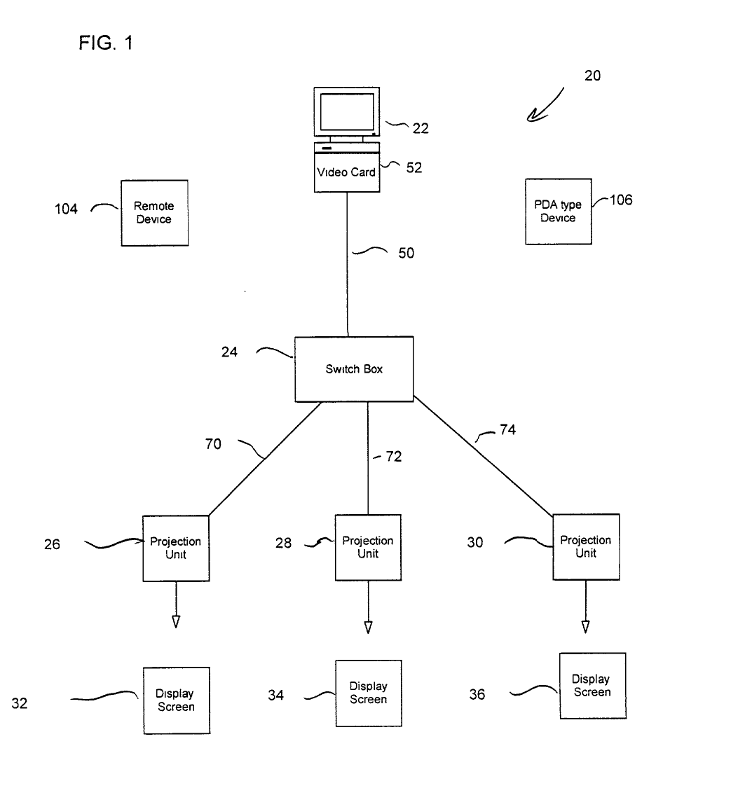

A system and method for presenting information onto a plurality of displays is disclosed. FIG. 1 is a simplified block diagram illustrating the components of a system 20 for presenting information onto a plurality of displays in the preferred embodiment of the present invention. The system includes a computing system 22, a switch box 24, and projection units 26, 28, and 30. Each projection unit projects a visual presentation to one of a plurality of display screens 32, 34, and 36.

The computing system may be any computer having a computer processor capable of processing data for display through the system 20. Any existing computer, such as a personal computer (PC) or laptop, may be used. However, in the preferred embodiment of the present invention, the computing system includes at least one conventional video card 52 to generate image signals for use by the projection units. The computing system is connected to the switch box 24 via a link 50. The link 50 is preferably a cable physically connected between the computing system 22 and the switch box 24. In one embodiment the link 50 comprises two junctions. A first junction connects the switch box to a port (such as a serial port) on the computing system dedicated to the transfer of video signals. A second junction is a cable connecting the switch box to another port located on the computing system and is dedicated to the transfer of command signals generated by the computing system 22. However, in alternate embodiments of the present invention, the link 50 may be a wireless link well known to those skilled in the art of networking.

The switch box 24 receives presentation data from the computing system 22 through the link 50. The switch box includes a microprocessor for perform the separation functions of the switch box. The switch box separates data into a plurality of distinct arrays. Each data array is sent to a designated projection unit for display on its associated display screen. The switch box sends the separated data arrays to the projection units through links 70, 72, and 74. The links 70, 72, and 74 may each be physically connected to the projection units, in a similar manner as the link 50. In an alternate embodiment of the present invention, the links 70, 72, and 74 may be wireless links.

Each projection unit 26, 28, and 30 is a conventional projection unit receiving data inputs originating from the computing system 22. The projection units may be conventional models normally used with computers. Each projection unit receives data through the switch box 24 and projects images onto the associated display screens 32, 34, and 36. In an alternate embodiment of the present invention, rather than project images onto a screen, the projection units may be monitors incorporating a video display within the projection unit.

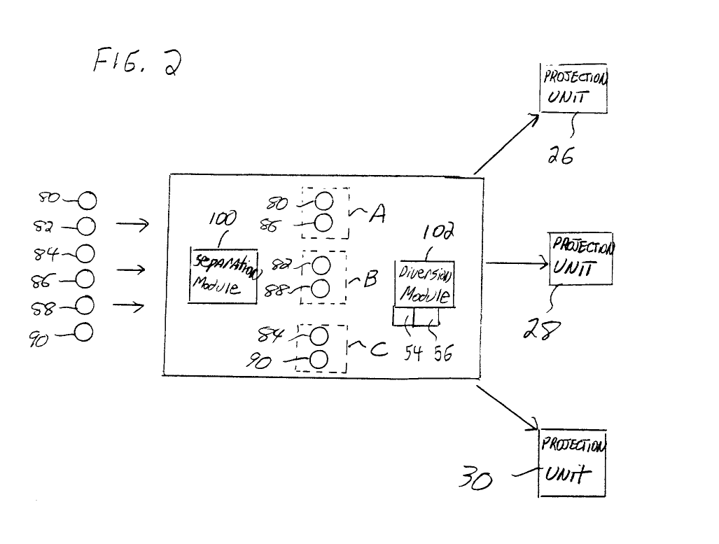

FIG. 2 is a simplified block diagram illustrating the influx of data packets through the switch box 24 in the preferred embodiment of the present invention. The computing system 22 sends a plurality of data packets 80, 82, 84, 86, 88, and 90 to the switch box 24. Each data packet includes data used for display upon a designated display screen. The data packet includes an identification tag which provides a designator for the switch box to determine the destination of each data packet. The switch box receives the data packets within the separating module 100 which separates each data packet into a specific array associated with a projection unit. In order to process the data packets, the switch box should include a memory storage device (not shown) to store the received data packets. Next, each array of data packets is diverted to the designated projection unit by a diversion module 102. Within the diversion module may be two or more video cards 54 and 56 for the generation of images for two or more screens. It should be understood that any device capable of generating images may be used in place of the video cards. Additionally, the amount of additional video cards is predicated upon the amount of desired projected images. For example, if five projection units are utilized, the switch box would preferably include four video cards, with the fifth video card residing within the computing system. In an alternate embodiment of the present invention, all the video cards may be located within the computing system. In still another embodiment, all the video cards are located within the switch box. Once the diversion module receives the separated arrays of data packets, the diversion module sends the arrays to the appropriate projection unit.

For simplicity in illustrating the system 20, FIG. 2 shows only data packets 80, 82, 84, 86, 88, and 90 entering the switch box 24 from the computing system 22. As discussed above, each data packet includes an identification tag specifying the destination of the data packet. The separating module separates the incoming data packets into arrays associated with a designated projection unit. For example, data packets 80 and 86 are designated for projection unit 26, data packets 82 and 88 are designated for projection unit 28, and data packets 84 and 90 are designated for projection unit 30. The separating module separates the data packets 80 and 86 as an array A, the data packets 82 and 88 as an array B, and data packets 84 and 90 as an array C. The diversion modules receives the arrays and generates image signals through the video cards 54 and 56 for arrays B and C. Array A may include images already generated from the video card 52 residing within the computing system 22. However, all arrays may pass through video cards residing within the switch box to generate the requisite image signals. Once all the arrays have been converted into video signals, the diversion module diverts each array to the appropriate projection unit. As illustrated, array A of data packets is sent to projection unit 26, array B of data packets is sent to projection unit 28 and array C of data packets is sent to projection unit 30.

Upon receipt of the data packets sent from the switch box 24, each projection unit projects the data as images upon its associated display screen. Although visual data may be displayed on each display screen, in alternate embodiments of the present invention, audio signals may also be separated by the switch box for dissemination to a designated projection unit or a separate speaker system. The audio signals may be sent via the existing links 50, 70, 72, and 74 or through separate links.

Referring back to FIG. 1, the system 20 may include one or more remote devices 104 allowing remote manipulation of the computing system 22, switch box 24, or a designated projection unit. The use of remote devices for sequencing through a presentation via a computer is well known and may be incorporated within the disclosed system. In one embodiment, the switch box and computing system may include infrared ports for the receipt of signals generated from the remote devices. Additionally a personal data assistant (PDA) type device 106 may be utilized to provide an operator of the system 20 a device to write or draw images for display upon one or more of the display screens. In such a configuration, the PDA type device 106 may be connected via wire or wireless link to the computing system 22 or the switch box 24. The images received from the device 106 are converted to electronic signals and sent to the projection unit designated by the operator. The images produced by the operator may be overlaid existing images on the display screens or separately displayed.

With reference to FIGS. 1 and 2, the operation of the system 20 will now be explained. An operator of the system inputs data into the computing system 22. The data is compiled into a format suitable for a presentation. The computing system may utilize conventional software programs suitable for presentations. The computing system 22 creates data packets in a format readable by each projection unit for display of the information. Software is utilized to provide the operator a selection of a destination projection unit for which each data packet will be sent. The software residing within the computing system also identifies each data packet with an identification tag indicating the selected projection unit destination selected by the operator. In addition, the computing system's video card 52 may convert data packets destined for one “direct feed” projection unit into image signals readable by the direct feed projection unit. The computing system then sends the data packets to the switch box 24. In an alternate embodiment of the present invention, the image signals generated by the video card 52 may bypass the switch box and be sent directly to the designated direct feed projection unit. The separating module 100, located within the switch box 24, determines the desired destination from the identification tag of each data packet. The separating module separates the data packets into arrays based on projection unit destination. Next, the separated data packets are sent to the diversion module 102, also located within the switch box, where the arrays of data packets not converted by the video cards 52 are converted into image signals by the video cards 54 and 56. The data packets are then sent to the appropriate projection unit. Once received by the appropriate projection unit, the projection unit displays the received data on its associated display screen.

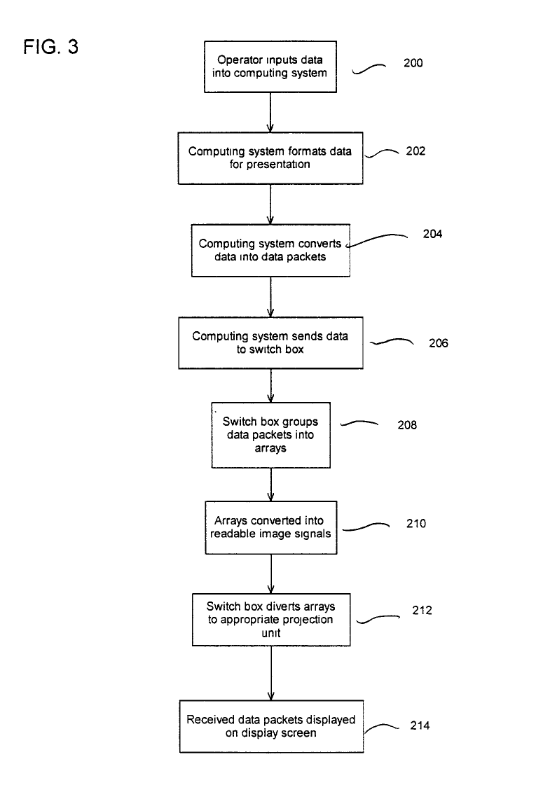

FIG. 3 is a flow chart outlining the steps for presenting information to a plurality of displays according to the teachings of the present invention. With reference to FIGS. 1, 2, 3A and 3B, the steps of the method will now be explained. The method begins with step 200 where an operator inputs data into the computing system 22. The input data is any information for which the operator wishes to present to an audience. The operator also selects the destination projection unit or units for the inputted information. Next, in step 202, the computing system transforms the inputted data from the operator into a format appropriate for the audience. Any software allowing presentation of the information may be utilized. The data may include video and audio data. The method then moves to step 204, where the computing system converts the data into signals called data packets. The computing system provides an identification tag for each data packet associating the data packet with a designated projection unit selected by the operator. The computing system, through the video card 52, may also optionally convert the data packets destined for a designated direct feed projection unit into image signals readable by the projection unit. Next, in step 206, the data is transmitted in data packets, such as data packets 80, 82, 84, 86, 88, and 90 to the switch box 24.

In step 208, the data packets, each having an identification tag associating each data packet to a specified projection unit, are separated into arrays. For example, data packets 80 and 86 are designated as array A having a destination of the projection unit 26. Data packets 82 and 88 may be designated as array B, having a destination of the projection unit 28. The data packets 84 and 90 may be designated as array C, having a destination of the projection unit 30. Next, in step 210, the arrays that have not already been converted into readable image signals by the projection units, are converted into readable image signals by the video cards 54 and 56 within the diversion module. In step 212, the arrays are then diverted to the appropriate projection unit by the diversion module 102. The diversion module determines and sends each array to the designated destination. Next, the method moves on to step 214, where the transmitted data packets (arrays) are projected onto each designated projection unit.

In an alternate embodiment of the present invention, the functions of the computing system 22 may be incorporated within the switch box 24. For example, additional computing processors may be incorporated within the switch box for the processing of the information from the operator. Additionally, all command functions may originate from the switch box. It should be understood, that the functions of the switch box and the computing system may be located or co-located anywhere in the system 20.

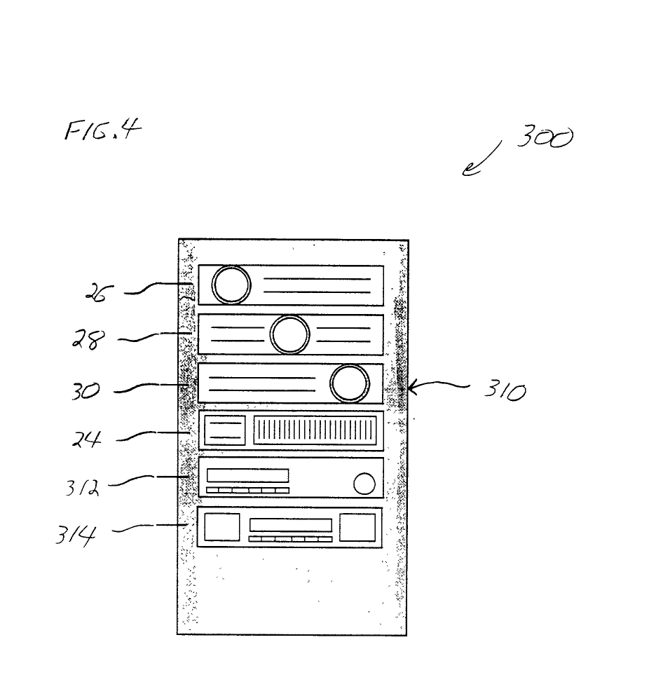

FIG. 4 is a front view of a presentation system 300 in an alternate embodiment of the present invention. The system 300 is similar to the system 20 in that the system 300 provides the presentation of data on a plurality of screens. The system 300 includes a plurality of projection units 302, 306, and 308 in one container 310. The container 310 also includes the switch box 24, a video cassette recorder (VCR) 312, and a digital video disc (DVD) player 314.

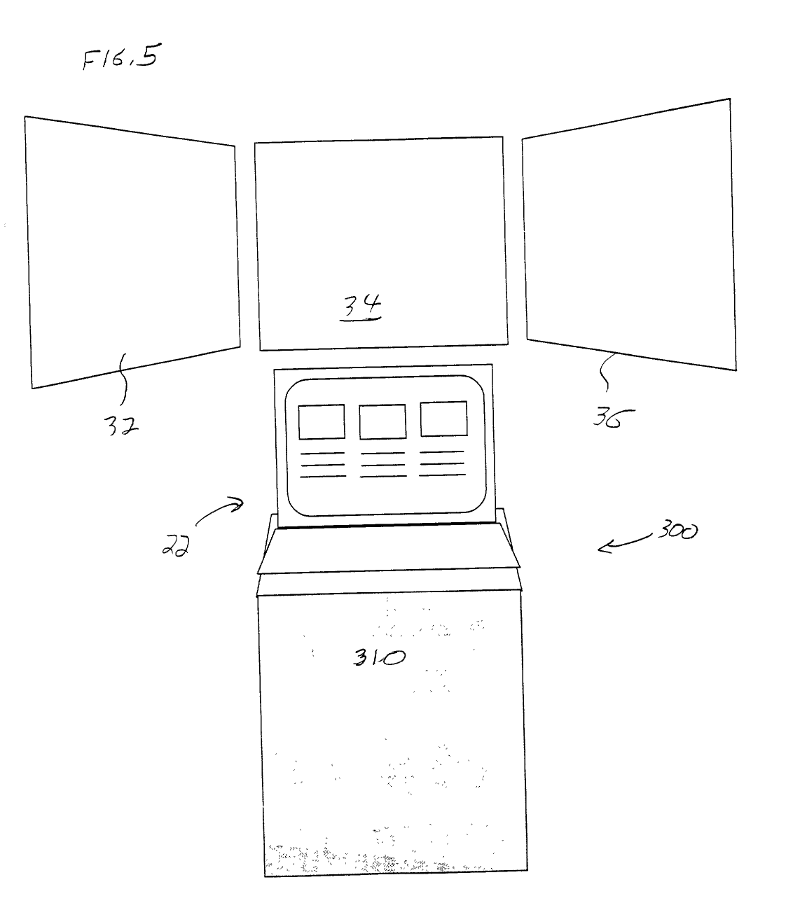

FIG. 5 is a rear view of the presentation system 300 of FIG. 4. The presentation system 300 also includes the computing system 22 located within an upper portion of the container 310. As illustrated, the computing system 22 is a laptop computer, providing additional mobility to the system 300. However, it should be understood, that any computer, such as a desktop computer may be used within the system 300. The system 300 utilizes the computing system 22, the switch box 24, and the plurality of projection units 26, 28, and 30 in the same manner as the system 20. However, the system 300 incorporates the various components into one container, thereby providing a mobile presentation system.

In addition, the system 300 may utilize the DVD player 314 and the VCR 312 for presenting data to the display screens 32, 34, and 36. The video and audio signals produced by the DVD player and the VCR are channeled through the computing system 22, where the signals are sent as data packets with identification tags for indicating the designated projection unit destination to the switch box.

The DVD player and VCR may also be incorporated for use with the system 20. In addition, it should be understood that any electronic device used to present data to people may be incorporated with the systems 20 and 300. Also, in an alternate embodiment of the present invention, the disclosed invention may position the switch box internally within the computing system 22. In addition, although three projection units and display screens are illustrated, any number of multiple screens may be utilized. The computing system may also be connected to private or public network system, such as the Internet, which feeds information to the computing system. Such data may be transferred for presentation to a presentation unit through the switch box.

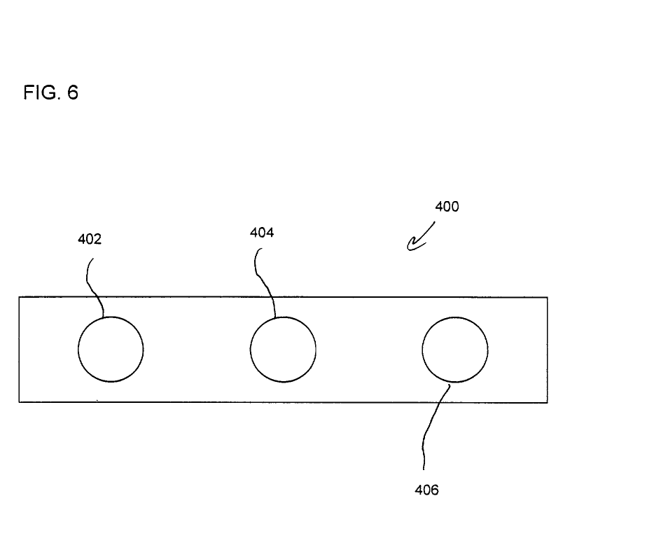

FIG. 6 is a front view of an integrated projection unit 400 which may be incorporated within the system 300 in a second alternate embodiment of the present invention. The integrated projection unit 400 includes a plurality of lenses 402, 404, and 406 mounted adjacent to each other. The projection unit may include a single light source, such as a light bulb (not shown) which provides illumination to each lens. The illumination from the bulb may be diverted by a plurality of prisms. The projection unit then adds the advantage of utilizing merely one bulb for use by a plurality of projection units. In addition, the lenses 402 and 406 may be swivelable to allow the projection of images at other angles than in front of the projection unit. The disclosed invention provides many benefits not available with existing presentation systems. The disclosed invention allows only one person to operate the presentation system and still present information on multiple screens. As discussed above, the presentation of information on three screens has been found to be preferable. The system and method enables the operator to efficiently and effectively provide information to a targeted audience. In addition, the presentation system is mobile, thus providing ease of use in various locations.

It is thus believed that the operation and construction of the present invention will be apparent from the foregoing description. While the system and method shown and described has been characterized as being preferred, it will be readily apparent that various changes and modifications could be made therein without departing from the scope of the invention as defined in the following claims.

What is claimed is:

1. A system for presenting information onto a plurality of display screens, the system comprising:
a computing system which receives information for presentation, said computing system formatting the information into a plurality of data packets, each data packet indicating a final destination designated from the received information;
a switch box communicating with the computing system, said switch box receiving a plurality of data packets sent from the computing system and determining a destination of each data packet; and
a plurality of display screens providing a display of information inputted into said computing system, said plurality of display screens communicating with said switch box;
whereby said switch box, upon determining the destination of each data packet, sends the data packet to the designated display screen.

2. The system for presenting information of claim 1 wherein each display screen includes a projection unit projecting a visual display onto the display screen.

3. The system for presenting information of claim 1 wherein said plurality of display screens include three display screens, each display screen providing a visual display of the inputted information.

4. The system for presenting information of claim 1 wherein said switch box includes a separation module for dividing the plurality of data packets into arrays based on a designated display screen destination.

5. The system for presenting information of claim 1 wherein said switch box includes a diversion module for determining a display screen destination for each data packet received from said computing system.

6. The system for presenting information of claim 1 wherein said switch box is located within said computing system.

7. The system for presenting information of claim 1 further comprising a remote device for operating said computing system.

8. The system for presenting information of claim 8 wherein said remote device includes means for presenting images provided from drawings inputted by an operator on said remote device.

9. The system for presenting information of claim 1 wherein said plurality of display screens includes audio devices for emitting audio signals.

10. The system for presenting information of claim 1 further comprising a plurality of audio devices for emitting audio signals.

11. The system for presenting information of claim 11 further comprising an electronic device providing visual data to said plurality of display screens.

12. The system for presenting information of claim 11 wherein said electronic device is a video cassette recorder.

13. The system for presenting information of claim 11 wherein said electronic device is a digital video disc player.

14. The system for presenting information of claim 1 wherein said switch box includes means for converting the plurality of data packets into image signals readable by said plurality of projection units.

15. The system for presenting information of claim 14 wherein the means for converting the plurality of data is at least one video card.

16. The system for presenting information of claim 14 wherein said computing system includes means for converting selected data packets into image signals readable by a designated projection unit.

17. A method of presenting information onto a plurality of display screens, said method comprising the steps of:
inputting information, by an operator, into a computing system for display to one of a plurality of display screens;
formatting the inputted information, by the computing system, into a plurality of data packets, each data packet indicating a destination of one of the display screens;
sending, by the computing system, the plurality of data packets to a switch box;
determining, by the switch box, a destination for the plurality of data packets to one of the plurality of display screens;
sending, by the switch box, the plurality of data packets to each determined destination from the plurality of display screens; and
displaying, by the determined display screen, the data packets to an audience.

18. The method of presenting information of step 14 wherein the step formatting the inputted information includes providing an identification tag for each data packet to indicate a destination to one of the display screens.

19. The method of presenting information of step 14 wherein the step of determining, by the switch box, a destination for the plurality of data packets to one of the plurality of display screens, includes separating each data packet into a array based on a destination display screen.

20. A system for presenting information onto a plurality of display screens, the system comprising:
a computing system which receives information for presentation, said computing system formatting the information into a plurality of data packets, each data packet indicating a final destination designated from the received information;
a switch box communicating with the computing system, said switch box receiving a plurality of data packets sent from the computing system and determining a destination of each data packet, said switch box including:
a separation module for dividing data packets into groups based on a designated destination; and
a diversion module for determining the designated destination for each data packet received from said computing system; and
a plurality of display screens for displaying information inputted into said computing system, said plurality of display screens communicating with said switch box;
whereby said switch box, upon determining the destination of each data packet, sends the data packet to the designated display screen.
